(19) United States
(12) Patent Application Publication
(10) Pub. No.: US 2018/0211272 A1
(43) Pub. Date: Jul. 26, 2018

(54) COMBINATORIAL OPTIMIZATION USING A REDUCED SEARCH SPACE

(71) Applicant: Oracle International Corporation, Redwood Shores, CA (US)

(72) Inventors: SHUBHANGI DESHPANDE, Sunnyvale, CA (US); RANDALL BRUCE SMITH, Palo Alto, CA (US)

(21) Appl. No.: 15/411,282

(22) Filed: Jan. 20, 2017

(51) Int. Cl. G06Q 30/02; G06F 17/30

(52) U.S. Cl. CPC G06Q 30/0238; G06F 17/30595

(57) ABSTRACT

A system that determines irrelevant match conditions from a plurality of match conditions that may be applied to an item set associates each item in the item set with one or more tags. The system further characterizes each of a plurality of match conditions as a Boolean function of one or more tag operators, where each tag operator includes one or more tags, and where each tag operator generates a set of possible markings of the item set. The system generates each marking in the set of possible markings by removal of one unit of a different single item from the item set that matches the tag operators in the Boolean function of one or more tag operators. The system further eliminates match conditions that generate an empty set of markings when applied to the item set.

### FIELD

One embodiment is directed generally to combinatorial optimization systems, and in particular, to reducing the size of the search space for such systems.

### BACKGROUND

Combinatorial optimization generally involves determining an optimal solution from a finite number of possible solutions (i.e., a solution space). In combinatorial optimization, some decision variables have only discrete values which makes the optimization problem more difficult. Furthermore finding an optimal solution for a combinatorial optimization problem in a finite amount of time can be impeded due to the combinatorial explosion of possible solutions to the problem with the number of discrete decision variables and/or the size of the solution space. In such difficult cases the “finite amount of time” may increase exponentially with respect to the dimensions of the problem and/or the size of the solution space. Classical approaches such as enumeration (implicit enumeration, branch-and-bound, and dynamic programming), Lagrangian relaxation, decompositions, and cutting plane techniques or their combinations may not be computationally feasible or efficient to solve a combinatorial optimization problem of a practical size. One way to overcome the combinatorial explosion is to give up completeness in favor of feasibility by using heuristics. Heuristic methods are often implemented in order to seek a good solution to a complex combinatorial problem within a reasonable time. However when combinatorial optimization problems additionally include hard constraints, heuristic/metaheuristic methods often fail and perform poorly.

One application area for combinatorial optimization include determining the optimal set of discounts that may be applied to a purchased or ordered set of items that results in the most value for a customer. A retailer may offer customers dozens or even thousands of items, while also offering many discounts. Considering that some discounts may be mutually exclusive, there may be multiple sets of relevant discounts. In such a case, the customer will want to apply the combination of discounts that provide the lowest price. With many items, many discounts, complex discount-to-order matching criteria, and complex discount mutual-exclusion rules, finding the optimal set of discounts for an order may present a significant combinatorial optimization problem. In situations where the rules governing applicability of a discount to a set of purchased items are complex, it may be unacceptably inefficient to test discount applicability rules against each subset of items in a purchase when the set of discounts and/or purchased items is large. This would be particularly problematic for retail point of sales systems that must determine which discounts apply to a customer order, ideally as an order is entered, one item at a time.

Therefore, any system or process directed at identifying applicable discount and determining the optimal combination of applicable discounts that results in the lowest price must produce accurate results without being time and/or resource intensive. Existing solutions, however, do not scale well for large orders and/or large numbers of discounts, and typically apply only to certain ways of classifying purchased items and discounts characteristic of a particular business

### SUMMARY

One embodiment is directed to a system that determines irrelevant match conditions from a plurality of match conditions that may be applied to an item set. The system associates each item in the item set with one or more tags. The system further characterizes each of a plurality of match conditions as a Boolean function of one or more tag operators, where each tag operator includes one or more tags, and where each tag operator generates a set of possible markings of the item set. The system generates each marking in the set of possible markings by removal of one unit of a different single item from the item set that matches the tag operators in the Boolean function of one or more tag operators. The system further eliminates match conditions that generate an empty set of markings when applied to the item set.

### BRIEF DESCRIPTION OF THE DRAWINGS

FIG. 1 is a block diagram of a computer server/system in accordance with an embodiment of the present invention.

FIG. 2 is an operational flow diagram of an optimizer module for discount search space reduction, in accordance with an embodiment of the present invention.

FIG. 3 is a flow diagram of additional details of aspects of FIG. 2 in accordance with one embodiment.

### DETAILED DESCRIPTION

According to one embodiment of the invention, a general discount matching methodology based on the notion of tagged items is disclosed for combinatorial optimization in a point of sale system. A tag is a Boolean property of an item that is either present or not. Any tag can be applied to any item, so tags can be used to express any kind of ontology, in addition to hierarchies. In order to represent discount applicability, we introduce the notion of a “marking” of an order. A marking indicates how discounts have been applied to an order. In general, a discount may be applied several different ways, so when tracking how discounts apply to an order, it is natural to work with sets of markings. In order to evaluate discount applicability, a tag operator is introduced that may be applied to a set of markings to generate a resulting set of marked states, each of which indicates which items are being used by the discount. If the set of markings is empty, the discount's tag operators have failed to mark the order, and therefore the discount is not applicable to the order. Using tags for characterizing each item in an item set (order) and a combination of tag operators for defining discount application rules provides an efficient method for determining an irrelevant set of discounts with respect to a given set of purchased/ordered items that does not require constructing all possible subset of the purchased/ordered item set.

One embodiment of the present invention is directed to an efficient method for determining the set of inapplicable discounts to be ruled out as irrelevant for any given order. Combinatorial optimization problems are exponentially sensitive to the size of the search space, as such a preliminary pass that narrows the search by ruling out irrelevant discounts will benefit performance. A discount is considered irrelevant if there is no way for the ordered items to match the conditions under which the discount applies.

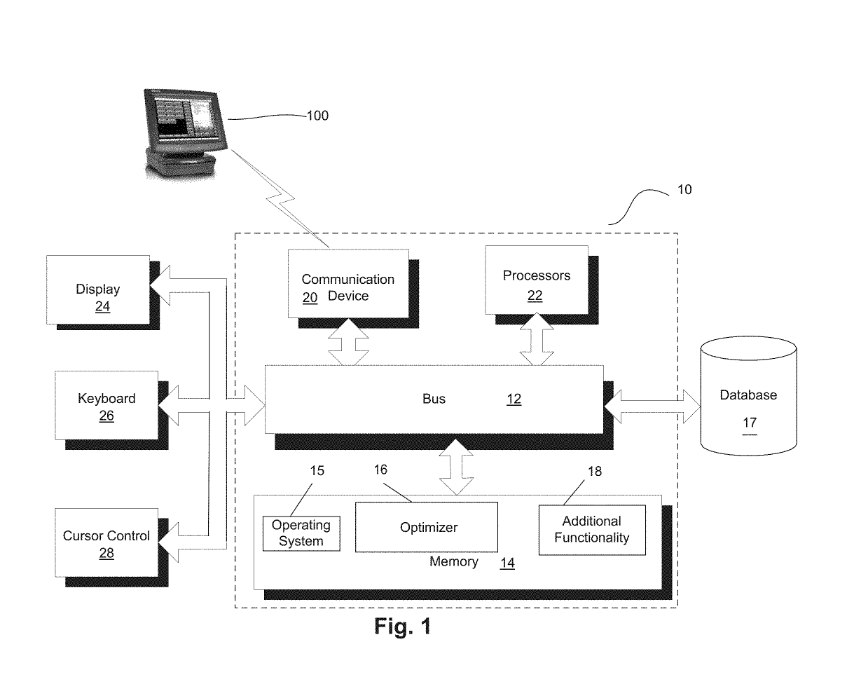

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, for functionality of a server, system 10 may need to include a processor and memory, but may not include one or more of the other components shown in FIG. 1, such as a keyboard or display.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an optimizer module 16 that automatically generates a set of irrelevant discounts for a customer's ordered/purchased set of items in order to simplify the subsequent process of generating an optimal set of discounts for the order, and all other functionality described herein. System 10 can be part of a larger system. Therefore, system 10 can include one or more additional functional modules 18 to include the additional functionality, such as a retail management system (e.g., the Oracle hospitality Restaurant Enterprise Series (“RES”) 3700 product suite) or an enterprise resource planning (“ERP”) system. A database 17 is coupled to bus 12 to provide centralized storage for modules 16 and 18 and store customer data, product data, transactional data, etc. In one embodiment, database 17 is a relational database management system (“RDBMS”) that can use Structured Query Language (“SQL”) to manage the stored data. In one embodiment, a specialized point of sale (“POS”) terminal 100 generates needed transactional data. POS terminal 100 itself can include additional processing functionality, including the functionality of module 16, in accordance with one embodiment.

As an example of an item set (order) with an irrelevant discount, consider an order that includes a sandwich, a salad, and coffee. Discount D1 is for a free coffee with an order of a sandwich, with a condition that D1 cannot be combined with any other discounts. Discount D2 is for a 10% price reduction on a salad, and discount D3 is for a free ice cream with an order of three sandwiches. Clearly, D3 cannot possibly apply to this order. Therefore D3 is considered an irrelevant discount. From the remaining discounts either D1 or D2 may be applied to the order, but not both. Discounts that are applicable but may not be optimal for a particular order (item set) are not considered irrelevant. The conditions required by D1 and D2 both apply, and it would be during the optimization step that an optimal option is selected from among the applicable options. Therefore, embodiments are directed to reducing the search space of the combinatorial optimization step by ruling out entirely irrelevant discounts like D3.

The operation of ruling out irrelevant discounts before optimization begins can bring considerable computational savings, but the technique may also be useful during the optimization process itself. For example, while performing the necessary optimization routines, the optimizer may enter a phase during which a discount is temporarily assumed to apply to a subset of items, for example S, in the original item set. In situations where multiple discounts cannot be applied to the same item, the optimizer may temporarily remove the matching items S from the order prior to searching for other discounts that may apply to the remaining items. The searching step may be further preceded by removal of irrelevant discounts for this now smaller set of items. Therefore, removal of the irrelevant discounts from consideration will enhance the optimization performance when executed prior and/or during the optimization phase.

Discount applicability rules can be quite complex, requiring tests for different combinations of various types of items some narrowly defined and some defined by collections of widely-held properties. Such rules can mix item count thresholds with cost thresholds, and offer several alternative ways of meeting the applicability requirements. Embodiments disclose techniques of high generality to enable its application to discounts of arbitrary complexity.

In accordance to one embodiment of the invention, a formal mathematical treatment for the problem of identifying the irrelevant set of discounts to be excluded from the search space of the optimization problem is disclosed.

Embodiments associate each item in the item set with a collection of tags. In one embodiment items may be retail items and item set may be a purchase order. Tags are simple immutable but distinguishable markers that characterize an item in a way suitable for discount matching. The discount matching test may be expressed as a Boolean function of these tags: if a discount matches the tags on any of the items in the item set (order), the discount can be applied to the order. If there is no way for a discount to match any item or subset of items in the order, the discount is considered to be irrelevant, and can be removed from the space of discounts for the subsequent optimization problem. The set of irrelevant discounts is referred to as the “irrelevant set.” Embodiments of the present invention disclose an efficient way to find the irrelevant set.

Consider two sets, one set is the set of available discounts, set A (the discounts), and the second is a power set (i.e., set of all subsets) of a set of ordered items, set B. The power set of B is denoted as P(B), the elements of A denoted as a, and the elements of P(B) denoted as s. Note that the elements s ∈ P(B) are themselves sets: each s is a particular subset of B. Furthermore, each element of A has a Boolean valued function on P(B), fₐ(s). The irrelevant set of A is defined as the subset of elements a E A for which fₐ(s)=false, ∀s ∈ P(B). These are elements a for which there is simply no subset of B that evaluates true.

One embodiment that uses a domain other than retail discounts involves characterizing which jobs a workshop can accomplish, given a set of tools. The jobs are set A, the tools are set B. P(B) is the set of all possible sets of tools. So each s ∈ P(B) simply represents some combination of tools. Each job requires such a combination of tools, but there are almost always more than one combination that will work, as some tools may be freely substituted for others, and extra tools still allow a job to be completed. So there are many sets of tools s that evaluate as true for a given job a. But even if a job has many distinct ways it can be accomplished by using a different distinct set of tools, it may be that each of those many ways requires some tool not found in the workshop, and so the workshop is unable to do the job. The irrelevant set is the collection of all such jobs (i.e., jobs the workshop is unable to accomplish).

In accordance to one embodiment of the invention, the discounts form set A, the items in the customer order form set B, and a discount either applies or does not apply to each possible combination of items (each set s ∈ P(B)). One approach to this problem is to construct all possible subsets s, and test them against each discount a ∈ A using fₐ(s). Constructing all possible sets s constitutes enumerating the full power set, P(B). But the size of the power set P(B) is an exponential function of the size of B, so it can be unrealistic to enumerate its elements.

One embodiment of the invention is directed to identifying the irrelevant set for a given A and B that does not require construction of the power set of B. This is based on a notion of generating markings of the set s.

Illustrated examples involve functions fₐ(s) that are based on arbitrary ‘and’ and ‘or’ combinations of Boolean properties of the elements in B. This domain is sufficient to capture most discounts. Nevertheless, it would be readily obvious to one of ordinary skills in the arts that exceptions involving, for example, function fₐ(s) that depends on the size of the set s taking on some exact value, may be addressed with obvious extensions and are therefore covered by embodiments of the present invention.

Tags, in one embodiment, are used as concise and flexible characterization of each item in an item set, such as a customer's purchase order (each element of 8). Each item holds a collection of zero or more tags, and as such may be a member of several tag groups simultaneously.

In many applications, such as the retail industry, tags can be a natural and useful way to categorize offered items. In a restaurant for example, tags may be identified by unique strings, such as “hamburger”, “children's menu”, “main entree”, or “appetizer”. A given menu item, such as a bacon cheeseburger, may bear several tags such as “sandwich”, “burger”, “bacon”, “cheese” , and “main item.” Some systems of tags may feature a universal tag, for example, called “item”. A discount that applies to any order may employ this universal tag.

When utilizing tags in the context of discounts, the function fₐ(s) may be referred to as a “matching test.” In this context fₐ(s) uses the tags on elements of s to determine if the combination of items represented by s matches the discount a.

In accordance to an embodiment of the invention, determining the applicability of a discount that avoids enumerating the power set is based on the notion of marking items in an item set such as a customer's purchase order.

Some (or none, or all) of the items in an item set (order) may be marked by a discount, if that set of items qualifies for the discount. The idea is that a discount marks an item in order to track which items were used to match the discount. In general there may be many ways for a discount to apply to (or mark) an order. The set of such markings represent the different ways a discount may apply to the order. If no marking are found for a discount, the set of markings is empty, Ø.

As an example, an order of a sandwich, a taco salad, a garden salad, and two coffees may be represented as a vector of how many of each items are not yet marked. Thus, the order is initially characterized as (1,1,1,2). Application of a discount D2 which provides 10% off the price of a salad to this initial order generates a markings set: {(1,0,1,2) , (1,1,0,2)}. Therefore for an initial unmarked order indicated as M₀, the set of markings of the order associated with a particular discount may be expressed as {M1 ,M2 ,Mn }. Application of discount D2 to the unmarked order M₀=(1,1,1,2) would generate markings M₁=(1,0,1,2), M₂=(1,1,0,2).

Marking vectors indicate the number of unmarked items remaining in an order. Therefore during the process of matching a discount to an order, some items are used up, and the number of items (if any) that remain would be available for further marking.

Although one way of representing a marking is illustrated above, it would be obvious to a person of ordinary skill in the art that different implementations may use arrays, sets, vectors, or arbitrarily complex data structures to represent the same.

Because of indistinguishability, the software object Mᵢ, corresponding to application of a discount to an entire menu of items numbered from 1 to N, indicates how many unmarked items remain for each of the N elements. Consequently Mᵢ may be represented as a simple vector of integers. The nth integer indicates how many of the nth item have NOT been matched by the discount.

Table 1 illustrates an example menu of items along with corresponding item tags. An initial unmarked order that includes two hamburgers and one of each other two items in the menu, may be represented as M₀=(2,1,1).

TABLE 1
Item Menu and corresponding tags

| | Item | Tags |
|---|---|---|
| 1 | Hamburger | “burger”, “sandwich” |
| 2 | Cheeseburger | “burger”, “sandwich”, “cheese” |
| 3 | Grilled Cheese Sandwich | “sandwich”, “cheese” |

For a discount based on the tag “burger” the generated markings set may be represented as {(1,1,1), (2,0,1)}. Both marked and unmarked orders are simply vectors and the integer elements of the vectors indicate how many of each item remain unmarked. Therefore, disclosed embodiments do not distinguish between an order of three hamburgers in which two have been marked, (1,0,0), and an unmarked order of a single hamburger, (1,0,0). Both have one more hamburger that can be marked, which is all the information that needs to be carried along.

In describing how tags may be used to mark an order as containing a match to a single item an item count tag operator T, informally referred to as “tag operator T” is introduced. A tag operator T is associated with a set of m tags: T=T(t₁, t₂, . . . , tₘ) and can mark an order in several possible ways. The intent is that Twill represent matching a single item that has all of the m tags. T is referred to as an operator because it can be applied to a state M₀ to generate a set of possible markings. Application of tag operator T to an unmarked state M₀ to generate a set of possible markings may be represented as shown in (1).

T·{M₀}={M₁, M₂, . . . , Mₙ} (1)

Note that in this formulation, a tag operator always operates on a set of markings and generates another set of markings. Hence in (1) the initial order with no items marked, M₀ appears as an element in a set. The marked states on the right hand side of (1) Mᵢ arise from M₀ by each having marked a single different item that matches all of the tags associated with T Mᵢ may be represented in terms of integer vector elements of a marked state as described above and illustrated in (2).

Mᵢ=(M_{i,1}, M_{i,2}, . . . , M_{i,N}); M_{i,j}≥0 (2)

The right hand side elements of (2) each have one less item available to be marked. Thus the representation in (3) holds true.

$${\sum }_{j = 0}^{N} {M}_{i , j} = {\sum }_{j = 0}^{N} {M}_{0 , j} - 1 , if {\sum }_{j = 0}^{N} {M}_{0 , j} \geq 1 \qquad ( 3 )$$

If Σⱼ₌₀^{N} M_{0,j}=0 any tag operator will generate an empty set as shown in (4)

T·{(0, 0, . . . , 0)}=Ø (4)

The tag matching for tag operator T is considered as failed when a tag operator T produces no matching states with a non-empty order M₀, as shown in (5).

T·{M₀}=Øif M₀ has no matching tags (5)

Tag operator T may operate on larger sets of vectors Mᵢ as shown in (6)

T·{M₁, M₂, . . . , Mₙ}=T·{M₁}∪. . . ∪T·{Mₙ} (6)

A tag operator whose tags are “sandwich”, and “cheese”, such that: Tsc=Tsc(“sandwich”,“cheese”) when applied to an order that includes two of each menu items in table 1, represented as M₀=(2,2,2), would mark one of the cheeseburgers or one of the grilled cheese sandwiches, but not the hamburgers, resulting in two possible markings as shown in (7).

Tsc·{M₀}={(2,1,2), (2,2,1)} (7)

Due to the indistinguishability property, all the ways to mark both distinct instances of the cheeseburger or grilled cheese sandwich need not be represented. Rather, a tag operator uses up to at most one mark for each menu item element of the vector. Applying a tag operator to larger sets of markings arises when specifying multiple matching items. As an example of applying T_{sc} to a set with multiple elements, i.e., the markings set from (7), is shown in (8).

T_{sc}·{(2,1,2), (2,2,1)}=T_{sc}·{(2,1,2)}∪T_{sc}·{(2,2,1)}={(2,0,2), (2,1,1), (2,2,0)} (8)

In order to define a discount that will match an item if one tag or another is present, the ‘+’ (read “or”) operator for tags is utilized as shown in (9).

(T₁+T₂)·{M}=T₁·{M}∪T₂·{M} (9)

Defining tag operators in (9) as T_{b}=T_{b} (“burger”) and T_{c}=T_{c}(“cheese”) and applying the discount match test in (9) to an order M₀=(2,2,2) that includes two of each menu items in table 1, generates a markings set shown in (10).

(T_{b}+T_{c})·{M₀}={(1,2,2), (2,1,2)}∪{(2,1,2), (2,2,1)}={(1,2,2), (2,1,2), (2,2,1)} (10)

Even though there are two ways to mark “burger”, and two ways to mark “cheese”, there are only three elements in the resulting set, as set semantics disallows multiple occurrences of the same element.

The above examples illustrate a single tag operator that matches only if an item has both a “cheese” tag and a “sandwich” tag, T(“cheese”, “sandwich”). In Boolean logic, any combination of “and” and “or” requirements can be expressed as a series of “or's” between suitably chosen “and” requirements. Consequently, disclosed formulation of tag operators with the+operation among them can express any logical Boolean requirement of “and” and “or” among tags. Therefore, although it would be possible to introduce an “and” operation between tag operators to represent a single operator to match an item with all the tags of two different operators, doing so would not provide expressive power beyond what is already available.

Many discounts (such as “combo meals”) require an order to contain several different items. To represent matching multiple items, it is sufficient to serially apply various tag operators to an item set (order) such as: T₁·T₂· . . . · Tₙ{M}. Here the intent is to match n different items, and in this case the word “and” for the dot operation is used to express matching one item and another item. Therefore T(“soup”) ·T(“salad”) represents a match for two items, one tagged “soup” and another “salad” and is not equivalent to T(“soup”,“salad”), which represents a match for a single item that, for the purpose of this example, is both “soup” and “salad”.

From the expression shown in (8), it follows that a multiple item matching discount expressed as T₁·T₂ may be applied to an unmarked order M₀ according to the relation shown in (11).

T₁·T₂·{M₀}=T₁·{M₁}∪T₁·{M₂}∪ . . . ∪T₁·{Mₙ} (11)

In referencing (11), it would be apparent to a person of ordinary skill in the arts that the “and” operator can be recursively applied using three or more tag operators. The interaction between “and” and “or” operators, in particular the distributive property of “and” over “or,” is shown in relation (12). This property is useful in achieving the assertion that any combination of “and” and “or” requirements can be expressed as a series of “or's” between suitably chosen “and” requirements.

T₁·(T₂+T₃)=T₁·T₂+T₁·T₃ (12)

The relation expressed in (13) illustrates the process of applying a discount match test characterized as a combination of a tag operator associated with a “burger” tag and a tag operator associated with a “cheese” tag, (T_{b}·T_{c}), to unmarked order, M₀=(2,2,2), of above examples:

$${T}_{b} \cdot {T}_{c} \cdot \{ ( 2 , 2 , 2 ) \} = {T}_{b} \cdot \{ ( 2 , 1 , 2 ) \} ⋃ {T}_{b} \cdot \{ ( 2 , 2 , 1 ) \} = \{ ( 1 , 1 , 2 ) , ( 2 , 0 , 2 ) \} ⋃ \{ ( 1 , 2 , 1 ) , ( 2 , 1 , 1 ) \} = \{ ( 1 , 1 , 2 ) , ( 2 , 0 , 2 ) , ( 1 , 2 , 1 ) , ( 2 , 1 , 1 ) \} \qquad ( 13 )$$

As may be observed from the final outcome in (13) there are four ways for the order M₀=(2,2,2) to match the discount (T_{b}·T_{c}). Element (2,1,2) is not present in the final markings set in (13). This is because marking only a single cheeseburger does not satisfy the requirement of “cheese and burger.” The use of this particular “and” operation ‘·’ necessarily results in two marked items.

Consider an order selected from the menu items in Table 2 that consists of an Egg Roll and a Salmon entree. A discount offering 10% off any order that includes an appetizer item and a seafood item may be successfully matched to this order as illustrated by the outcome (≠Ø) of the match test expressed in (14).

TABLE 2
Menu of items and corresponding tags

| | Item | Tags |
|---|---|---|
| 1 | Shrimp Cocktail | “seafood”, “appetizer” |
| 2 | Egg Roll | “appetizer” |
| 3 | Salmon entree | “seafood” |

T(“seafood”)·T(“appetizer”){(0,1,1)}=T(“seafood”){(0,0,1)}={(0,0,0)} (14)

Consider applying the above discount to a second order consisting of a shrimp cocktail only. The usual intent of this discount is to reward the customer who orders two appropriate items, but the shrimp cocktail features both tags in one item. In the case of this order discount matching test fails as shown by empty set (Ø) outcome in (15).

T(“seafood”)·T(“appetizer”){(1,0,0)}=T(“seafood”){(0,0,0)}=Ø (15)

A discount created to allow an item such as shrimp cocktail to qualify for a discount on seafood and appetizer must be defined as expressed in (16) in order for it to be applicable to an order consisting of a seafood item and an appetizer item, or an order consisting of an item that is both seafood and an appetizer.

T(“seafood”)·T(“appetizer”)+T(“seafood”,“appetizer”) (16)

When expressing a match test for a discount, it may be useful to introduce an intermediate construct denoted as “Item Test”, for marking a single item. An Item Test may be expressed as a “or” of a collection of tag operators.

I=(T₁+T₂+ . . . Tₘ) (17)

Item tests are useful as the discount creator normally thinks at the level of individual items, only using tags to help specify which item or items qualify for the discount. Any run of sums of tags could be grouped into an item test, as shown in (17). Therefore, a discount's match test may be expressed in terms of suitably chosen item tests, often in multiple ways. Because of the distributed property of Boolean ‘·’ (and) operator over Boolean ‘+’ (or) operator, a combination of item test operators Iᵢⱼ may be identified, such that the discount match test may be expressed in the form:

$${\sum }_{i = 0}^{n} {\prod }_{j = 0}^{{m}_{i}} {I}_{ij} \qquad ( 18 )$$

This may be used as a canonical form for defining a discount's match test. The match test is a sum of terms, each being a product of item tests. This form would correspond to a applicability condition that, for example, requires an order of item A and item B and item C, or, an order item A and item D.

Many discounts are expressed in terms of a cost threshold (i.e., spend more than $3 on sandwiches and get a free cookie). In order to support such cost threshold based discount applicability tests, three extensions may be added to the discount match/applicability test expression. One such extension called a cost accumulator is added to the marking vector to enable tracking of the accumulated amount spent on marked items. The cost accumulator will be positioned at index 0 in the extended marking vector M, and will be denoted as separate by a vertical as shown in (19). Any initial unmarked order will have its cost accumulator set to 0.00.

M=(0.00|2,7,9) (19)

The second extension which is a new kind of tag operator called a cost accumulating tag operator (denoted as T⁺) may be implemented to serve as the item count operator, with a function of also adding the cost of the matching item to the zeroth element of M, the cost accumulator. The third extension, added to the discount match or applicability test expression is a filter operator, F(c), which is parameterized by a cost c. The filter operator will remove any markings in a set of markings whose zeroth element is below the threshold quantity c. In practice the cost accumulating tag operators T⁺ will always be accompanied by a filter which would appear to their left, to be applied after the costs have been accumulated. In practice, there would be no purpose in accumulating costs if no filter is applied, although embodiments of the invention technically allow it.

Any markings that survive the filtering operation of F will have their cost accumulator reset to 0. This is so that subsequent cost accumulation and filtering can reuse the accumulator. That is, the cost accumulator keeps track of how much is spent on some item, and the repeated serial application of cost accumulating tag operators with a filter each reuse the cost accumulator, resetting it to 0 after being applied so it is available for the next set of tag operators and filter.

Referencing the menu in table 2 (shrimp cocktail, egg roll, salmon entree), and assuming an egg roll costs $1.50 and shrimp cocktail costs $5. The Discount Applicability test for a matching condition (discount) based on spending more than $4.00 on two appetizers applied to an order of one egg roll and one shrimp cocktail is expressed in (20):

$$F ( 4.00 ) \cdot {T}^{+} ( “ appetizer ” ) \cdot {T}^{+} ( “ appetizer ” ) \cdot \{ ( 0.00 \vert 1 , 1 , 0 ) \} = F ( 4.00 ) \cdot {T}^{+} ( “ appetizer ” ) \cdot \{ ( 5.00 \vert 0 , 1 , 0 ) , ( 1.50 \vert 1 , 0 , 0 ) \} = F ( 4.00 ) \cdot \{ ( 6.50 \vert 0 , 0 , 0 ) \} = \{ ( 0.00 \vert 0 , 0 , 0 ) \} \qquad ( 20 )$$

The resulting match succeeds as the final set is not empty. However, when applied to an order of two egg rolls, as shown in (21), the test return an empty set and hence the resulting match fails

$$F ( 4.00 ) \cdot {T}^{+} ( “ appetizer ” ) \cdot {T}^{+} ( “ appetizer ” ) \cdot \{ ( 0.00 \vert 0 , 2 , 0 ) \} = F ( 4.00 ) \cdot {T}^{+} ( “ appetizer ” ) \{ ( 1.50 \vert 0 , 1 , 0 ) \} = F ( 4.00 ) \cdot \{ ( 3.00 \vert 0 , 0 , 0 ) \} = φ \qquad ( 21 )$$

A frequent condition is “spend more than $X on Y,” which implies any number of items tagged Y. One item, or two items, or three items, or four items, and so on:

F(X)·[T⁺(Y)+T⁺(Y)·T⁺(Y)+T⁺(Y)·T⁺(Y)·T⁺(Y)+ . . . ]

This condition is expressed according to the notation of (22).

$${T}^{+ *} = {\sum }_{n = 1}^{∞} {T}^{+ n} \qquad ( 22 )$$

It may seem that evaluating an infinite number of terms would be time consuming, however for any initial order M there exist some N sufficiently large such that:

T⁺ⁿ·{M}=Ø; ∀n>N

In other words, in practice there will always be some number of N repeated applications of T⁺beyond which there is no need to consider further terms, as an order M₀ can only contain finite number of items. An algorithmic reduction to practice of the disclosed formalism, according to an embodiment of the invention, will utilize this practical attribute for optimizing performance.

Filter operator F distributes over Boolean operator ‘+’ as shown in (23). However, Filter operator does not commute with the cost accumulating tag operator T⁺ as shown in (24). Filter operator F and cost accumulating tag operator T⁺ both commute with the item count tag operator T as shown in (25)

F·[T₁⁺+T₂⁺]=F·T₁⁺+F·T₂⁺ (23)

F·T⁺≠T⁺·F (24)

F·T₁⁺·T₂=F·T₂·T₁⁺=T₂·F·T₁⁺ (25)

A match condition or discount applicability rule requires either spending $15 on items tagged A, and $10 on items tagged B. Or, purchasing an item tagged C and D worth $5 or more along with 2 items tagged E or one item tagged F.” This match condition or discount may be expressed as a Boolean function of filter and tag operators as shown in (26).

F(15)·T⁺*(A)·F(10)·T⁺*(B)+F(5)·T⁺(C, D)·(T(E)·T(E)+T(F)) (26)

Because of distribution property, (26) can be converted to a form involving a sum of three terms each involving only the Boolean operator‘·’ as shown below:

F(15.00)·T⁺*(A)·F(10.00)·T⁺*(B)

+F(5.00)·T⁺(C, D)·T(D)·T(E)·T(E)

+F(5.00)·T⁺(C, D)·T(F) (27)

This suggests a canonical form able to express the most general discount match test,

$${\sum }_{i = 1}^{N} [ {\prod }_{j = 1}^{{J}_{i}} ( F ( {c}_{i , j} ) \cdot {\prod }_{k = 1}^{{K}_{i , j}} {T}_{j , k}^{+ (* )} ) ] [ {\prod }_{l = 1}^{{L}_{i}} {T}_{i , l} ] \qquad ( 28 )$$

Such a form can be used as the basis for an algorithm that finds irrelevant sets.

In the general discount match test expressed in (28), the sum expresses the idea that a discount may be applied to an order (may match an order) in various ways, any one of which is acceptable. Each of the N terms represents one possible way of matching the order. In detail, the matching test will require the order to have certain items present, or certain cost thresholds or item counts that need be met by items in the order. That is the purpose of the F and the various T operators in the expression: they represent the matching test as a combination of individual filtering and marking operations carried out on the order by the F and T operators.

Within a term, the product of operators AB, simply means that A operates on the result of B's operation. Again, when operating on the original customer order, each term will generate a set of markings, each marking indicating how that term could apply to the order. The sum of N terms over I will simply “add” together all the resulting markings. In set theoretic terms, the addition is the union of the sets resulting from each term i.

In general, a term consisting of many operators will not be organized in the order of (28). However the tag operators T_{i,l} can be moved to the right, as they commute with all the other operators. Similarly, each filter operator expression F(c_{i,j})·Π_{k'1}^{K}^{_{i,j}} T_{j,k}⁺(*) can be moved to the left, as the expression commutes with all other operators.

In (28), the first operators to encounter the order are those on the right, the product of ordinary (item counting) tag operators T_{i,l}, numbered rom I=1 1 to Lᵢ. This expresses a matching condition on Lᵢ items that must be present in the order.

The remainder of the term in (28) is a product of Jᵢ filterings operating on a product of cost-accumulating tag operator, T⁺(*). Each filter operator F(c_{i.j}) will produce a set or markings that result from filtering out markings whose accumulated cost are below threshold c_{i,j}. The accumulated costs arise from the product of product of K_{i,j} cost-accumulating tag operators. These express the matching condition of K_{i,j} items, indexed by k. Each such single item or, if the operator is an “any count” cost accumulating operator T⁺*, any number of items, must be present in the order. Any marked items with a cost not exceeding the value c_{i,k}, will be removed from the set by the filter operator F(c_{i,k}). Once (28) operates on a customer order, the final result will be a single set of markings. If the set is empty, that means the original order does not match the condition.

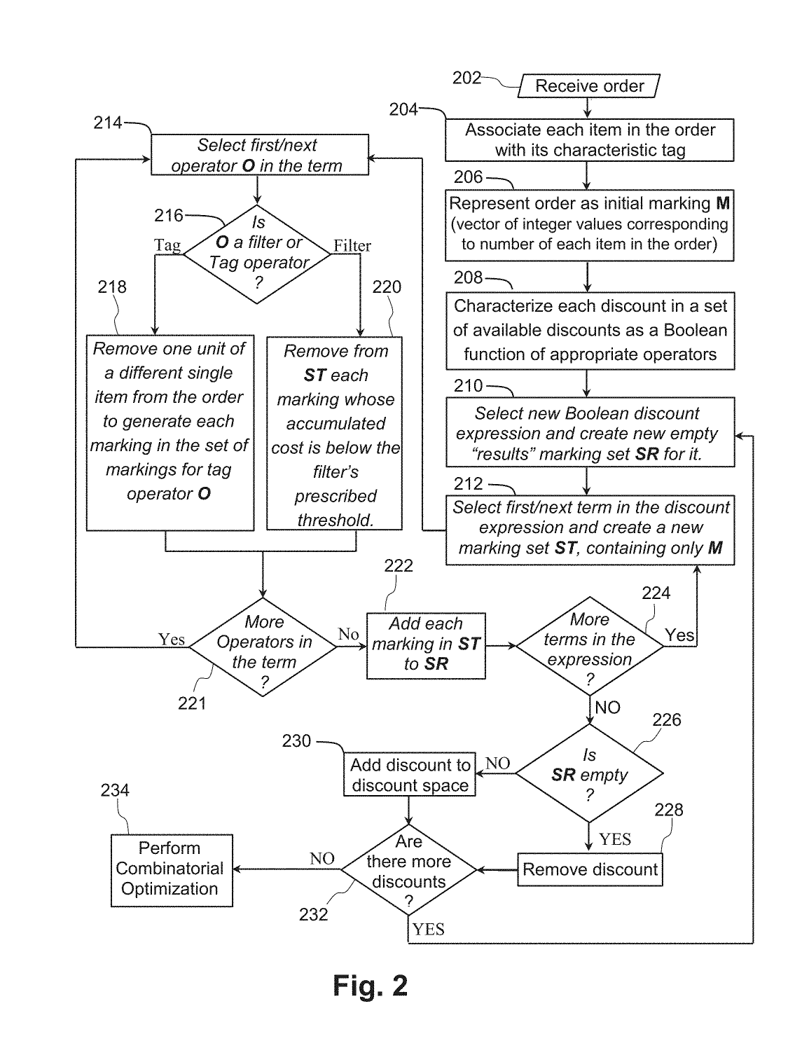

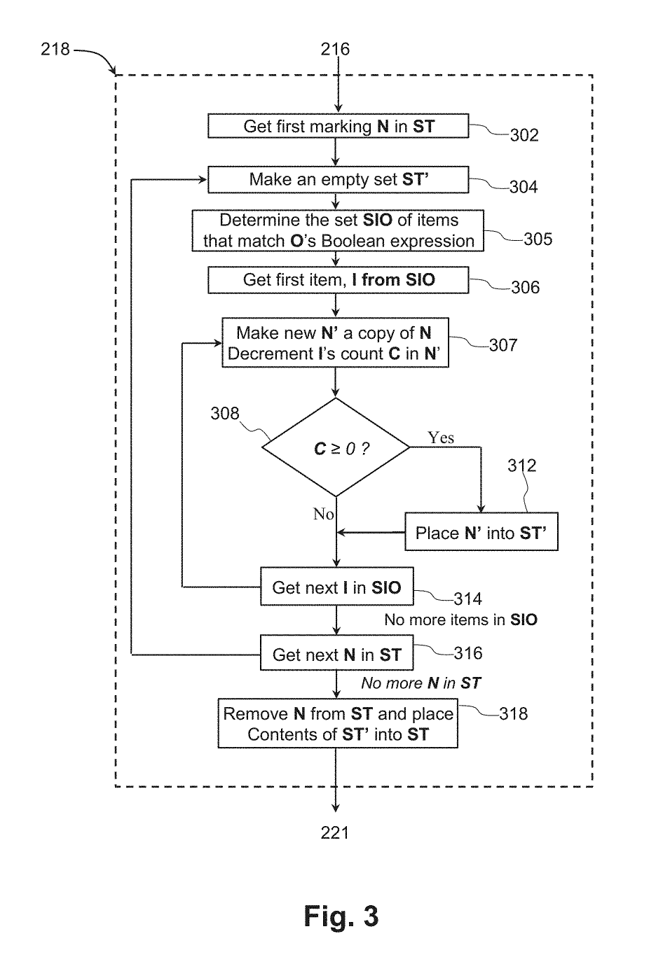

FIG. 2 is a flow diagram demonstrating the functionality of optimizer module 16 in FIG. 1 in accordance with one embodiment. In one embodiment, the functionality of the flow diagram of FIG. 2 (and FIG. 3 below) is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

In FIG. 2 at 202 optimizer module 16 receives an item set which according to one embodiment of the invention may include a set of purchased/ordered items that constitute a customer order. At 204 optimizer module 16 associates each item in the set of ordered items with its characteristic tags, which will be used later in the discount matching process. At 206 the order (item set) is represented as the initial marking M consisting of a vector of integer values each of which corresponds to the number of each item in the order. At 208 optimizer module 16 formulates a discount match test (Boolean discount expression), for each available discount, as a Boolean function of appropriate operators. In one embodiment the operators may consist of item count tag operators (tag operator) each of which is associated with one or more tags and/or filter operators for cost threshold matching.

At 210 a formulated discount match test for a particular discount is selected for match testing against the order and a new empty “results” marking set SR is created to store the markings generated as a result of applying the Boolean discount expression to the order referenced in 202. The operation continues to 212 where a Boolean term, taken from the discount match test expression is selected to be applied to the order and a new marking set ST, initially only containing M, is created to store the generated markings resulting from that action. The application of the Boolean term selected in 212 to the order is described in 214-222.

At 214 the first operator O in the term, selected at 212, is selected in accordance to the appropriate Boolean order. Each operator in the selected term of the formulated discount match test operates on the order set by generating a set of all possible markings associated with all different ways by which the operator may be applied to the order. The action taken by the operator depends upon the type of the operator as determined at 216. If the operator is an item count tag operator (tag operator), the process moves onto 218 wherein the tag operator is applied to the order to generate a set of possible markings of the order to be stored in the markings set ST for the respective term in the Boolean discount expression. Each marking in the set of all possible markings corresponds to the application of the tag operator to a different item(s) that match the tag operator. Moreover each marking in the set of possible markings ST generated by the application of the tag operator at 218 corresponds to the removal of one unit of a different single item in the order that matches the tag operator. Therefore multiple sets of markings are created during the process of applying the operators of the Boolean discount expression (discount match test) to a particular order. Additional details of the operation at 218 is illustrated in FIG. 3.

If the match condition specified by the discount is a cost threshold based match condition, i.e., the operator is a cost accumulating tag operator preceded by a filter operator, the operation moves from 216 to 220 in order to remove from the set of markings ST all markings for which the accumulated cost of marked items does not meet or exceed the prescribed threshold value expressed as a parameter of the filter operator.

The selected term from 212 is monitored at 221 for additional operators that have not yet been applied to the order. If additional operators are verified at 221, the process is repeated from 214 to 221 until there are no more operators in the selected term at which point the operation moves to 222 in order to transfer the content of the marking set ST to the “results” marking set SR. At 224 the discount expression is checked for the next term to undergo 212-222. If the Boolean discount expression (discount match test) contains no more terms the “results” marking set SR is checked for content as shown in 226. If SR is not empty the respective discount is retained in the list of applicable discounts and added to the discount space at 230 to be considered by the optimization process. If SR is empty the respective discount is deemed as a failed match for the order and is therefore removed as irrelevant as shown in 228. At 232 the set of available discounts is checked for any remaining discounts that have not been match tested against the order. 210 through 230 are repeated for any remaining discounts until all available discounts have been match tested against the order and the optimization discount space (applicable discounts) and an irrelevant discount space have been determined. At this point the discount space referenced in 230 contains only applicable discounts with respect to the order and the operation may move to 234 for performing combinatorial optimization to therefore determine the most optimal set of discounts from the now reduced discount space to be used for the order.

The flow diagram in FIG. 3 describes additional details of 218 in FIG. 2 for one embodiment. When an operator in a selected term of the discount expression is determined to be a tag operator, 302-318 are performed to generate markings of the order that result from the application of the tag operator to the order. At 302 the first marking N in the marking set ST in selected. At 304 an empty set ST' is created, the set SIO of items in the order that match O's boolean expression are determined and selected at 305. At 306 the first item, I from SIO is retrieved. At 307 a copy of N is created as N′ and item count C for the selected tag matching items is decremented by one count and stored in N′. At 308 the value of the item count C is checked and if it is determined to be greater than or equal to zero the operation moves to 312 in order to transfer the content of N′ to the empty set ST′ that was created at 304. Subsequently the operation moves to 314 in order to fetch the next item I in in SIO and 306-312 are repeated until there are no more item I in SIO. If the item count C is determined not to be greater than or equal to zero at 308 (i.e., if the item count C was zero prior to the item count being decremented in 306) the operation moves directly to 314 skipping 312. Once the operator O has been applied to all tag matching items I in the selected first marking N, the operation moves to 316 in order to select and retrieve the next N in ST. 304-314 are repeated for each marking N in the marking set ST. Once operator O has been applied to all the markings N in the marking set ST the operation moves to 318 in order to replace the content N of the marking set ST (representing the markings prior to application of the tag operator O) with the content of ST'(representing the markings post application of the tag operator O). The operation then moves to 221 as shown in FIG. 2.

Proof of distribution for item count tag operators by considering a Discount applicability condition expressed as a Boolean function of three tag operators is represented as T_{c}·(Tₐ+T_{b}). Therefore, for some arbitrary item set S corresponding markings set for tag operator Tₐ and T_{b} may be represented as Tₐ·S={Mₐ₁, Mₐ₂, . . . , Mₐₙ} and T_{b}·S={M_{b1}, M_{b2}, . . . M_{bm}}, respectively.

Because Boolean operator ‘+’ corresponds to the application of union operation on the resulting sets: T_{c}·(Tₐ+T_{b})·S=T_{c}·{Mₐ₁, Mₐ₂, . . . , Mₐₙ, M_{b1}, M_{b2}, . . . M_{bm}} which means, based on the definition of how an operator applies to a set of multiple elements: T_{c}·(Tₐ+T_{b})·S=T_{c}·{Mₐ₁}∪T_{c}·{Mₐ₂}∪ . . , T_{c}·{Mₐₙ}∪T_{c}·{M_{b1}}∪T_{c}·{M_{b2}}∪ . . T_{c}·{M_{bm}}. However the right hand side is T_{c}·Tₐ·S ∪ T_{c}·T_{b}·S=T_{c}·Tₐ·S+T_{c}·T_{b}·S. Thus it follows that for any set S, T_{c}·(Tₐ+T_{b})·S=(T_{c}·Tₐ+T_{c}·T_{b})·S

A sample pseudo-code describing one particular implementation of an embodiment of the invention is as follows:

// Instances of class Tag need have no specialized state or behavior, other
// than the ability to be distinguished from other tags, which it inherits from
// class Object. For convenience
// a Tag instance might be given a unique name, but this is not required.
Define class Tag subclass of Object {
}
//Instance of class Item may contain product specific information
//This implementation does not require any such specific information,
//only that individual instances of this class maintain a collection
// of tags.
// We assume there is a way to enumerate all the instances, this is used
// in the three methods of class MarkingSet.
Define Class Item {
//This items collection of Tag objects.

tags = new Collection( );
//Method to answer if this Item contains all the tags in the given collection of tags
tagsContainsAll(collection tagSet){

for(each tag t in tagSet){

if(tags.doesNotContain(t)) return false;

}
return true;

}

}

// Objects that implement the interface Marking act as a table,

// internally maintaining a count
// for each instance of class Item.
// An instance of Marking also maintains a costAccumulator, which
// may be used by certain tag operators.
// When a customer order arrives, it is defined by a Marking
// indicating how much of each Item was ordered. The cost
// accumulator is initially set to 0.0. That marking is placed in a
// MarkingSet, so the customer order starts out as the sole Marking
// in a MarkingSet.

Define Interface Marking{

getCostAccumulator( );
setCostAcumulator(double cost);

getCountAt(Item i);
setCountAt(Item i, int count);

}

Define Class MarkingSet subclass of Set {

markings = new Set( ); // Holds the collection markings

/////
//Methods for marking. These have a functional style, returning a new markingSet
/////
//mark and return a MarkingSet

mark(Collection tags){

newSet = new MarkingSet( );
for(each marking m in this set){

for(each item in allInstances of class Item){

if(item.tagsContainsAll(tags)){

if(m.getCountAt(item) >0){

newMarking = m.copy( );
newMarking.setCountAt(item, m.getCountAt(item) − 1);
newSet.add(newMarking);

}

}

}

}
return newSet;

}
//Mark and return a potentially smaller set, but also
//accumulate item costing the costAccumulator field.
markAndAccumulateCost(Collection tags){

newSet = new MarkingSet( );

for(each marking m in this set){

for(each item in allInstances of Item){

if(item.tagsContainsAll(tags)){

if(m.getCountAt(item) >0){

newMarking = m.copy( );
newMarking.setCountAt(item, m.getCountAt(item) − 1);

x = m.getCostAccumulator( ) + getCostOfItem(index);
newMarking.setCostAccumulator(x);

newSet.add(newMarking);

}

}

}

}
return newSet;

}
//Return markings but exclude those whose cost accumulator are below threshold
filteredByCost(double threshold){

newSet = new MarkingSet( );

for(each marking m in this set){

if(getCostAccumulator( ) > threshold){

newMarking = m.copy( );

newMarking.setCostAccumulator(0.0);

newSet.add(newMarking);

}

}
return newSet;

}

}
Define Class Discount {

// operatorTerms is an
// indexed collection, each element is itself a collection of
// operators that constitute a single “term.”
// The operatorTerms encode the matching rules,
// determining if this discount can apply to an order.
// Each terms represents a condition that may apply,
// and these conditions are combined using “OR” logic.
// There will always be at least one term, so one collection inside
// operatorTerms.
// The operators within a single term are combined using “AND” logic.
operatorTerms = new Collection( );
// Method to add an operator as the last operator in the indicated term.
addToTerm(int index, Operator op){

if(operatorTerms.get(index) == null){

//This is the first operator in this term
operatorTerms.set(index, new Collection( ));

}
operators = operatorTerms.get(index);
operators.addLast(op);

}
// Determine if this Discount is irrelevant. This Discount is
// irrelevant if the resulting Marking set is empty.
cannotApplyTo(MarkingSet customerOrder){

MarkingSet result = new MarkingSet( );
for(operators in operatorTerms){

mSingleTermMarking = customerOrder; //Each term operates on the customerOrder
for (op in operators) {

mSingleTermMarking = op.applyTo(mSingleTermMarking);

}
result = result.union(mSingleTermMarking); //Collect all the results

}
//cannot apply if it is empty.
return result.isEmpty( );

}
}
////////
//
// OPERATORS
//
////////
Define Interface Operator {

//Generate and return the new MarkingSet that results from applying this operator
appyTo(MarkingSet m);

}
Define Class TagOperator implements Operator {

//Instance variables or “fields”
// A collection of the tags that must be
// present in any item that this operator will mark.
tags;
//Methods
addTag(Tag t){tags.add(t);}
applyTo(MarkingSet m){

return m.mark(tags);

}

}
Define Class TagCostOperator subclass of TagOperator {

applyTo(MarkingSet m){

return m.markAndAccumulateCost(tags);

}

}
Define Class TagAnyCountCostOperator subclass of TagCostOperator {

applyTo(MarkingSet m){

result = new MarkingSet( );
pass = super.applyTo(m);
result = result.union(pass);
while(pass.isNotEmpty( )){

pass = super.applyTo(pass);
result = result.union(pass);

}
return result;

}

}
Define Class Filter implements Operator {

//Instance Variables or “Fields”
threshold = 0.0;
//Methods
applyTo(MarkingSet m) {

return m.m.filteredByCost(threshold);

}

}

As disclosed, embodiments allow for reliable and accurate determination of an optimum solution. For example, a best discount profile that may be constructed from a set of available discounts for a purchased/ordered set of items, in a combinatorial optimization process that exhibits the reliability and accuracy of an exhaustive search without the associated drain on time and computing resources. This performance improvement is achieved, in accordance to one embodiment of the invention, by eliminating irrelevant discounts and therefore achieving a reduced optimization search space without testing the applicability of each discount against every possible combination of items in a customer order which would involve enumeration of the full power set of ordered items.

Embodiments disclose a tag based representation of an order and representation of a discount as a set of match conditions/tests expressed as Boolean function of discount tag operators. The discount tag operators in the Boolean discount expression operate on an order by generating a set of markings each of which represent one possible way a discount tag operator can match the order (ordered set of items). Consequently, the Boolean discount expression operates on an order to generate a single set of markings representing all possible ways the corresponding discount may be applied to the customer order. An outcome consisting of an empty set indicates that the discount is irrelevant to the order and should be removed from the optimization search space.

The disclosed embodiments present an improvement over known solutions in several ways: Formal representation of disclosed embodiments suggest that the outcome may be reliably regarded as being correct even with arbitrarily complex discount applicability rules. In addition, the general characterization of inventory of available items based on tags or group identifiers renders the disclosed embodiments applicable to many different businesses across many different industries. Furthermore, in contrast to a standard scaling factor of 2̂(number of purchased items), the performance of the disclosed embodiments scales linearly with the size of the item set.

Several embodiments are specifically described herein. However, it will be appreciated that modifications and variations of the disclosed embodiments are covered by the above teachings and within the purview of the appended claims without departing from the spirit and intended scope of the invention.

What is claimed is:

1. A non-transitory computer-readable medium having instructions stored thereon that, when executed by a processor, determine irrelevant match conditions from a plurality of match conditions for an item set, the determining comprising:
associating each item in the item set with one or more tags;
characterizing each of the plurality of match conditions as a Boolean function of one or more tag operators, wherein each tag operator comprises the one or more tags, and wherein each tag operator generates a set of possible markings of the item set, wherein each marking in the set of possible markings is generated by removal of one unit of a different single item from the item set that matches the tag operator; and
eliminating match conditions that generate an empty set of markings when applied to the item set.

2. The non-transitory computer readable medium of claim 1, wherein the item set comprises a set of purchased items.

3. The non-transitory computer readable medium of claim 2, wherein a tag represent a distinct category of the item.

4. The non-transitory computer readable medium of claim 3, wherein the match conditions comprise discount applicability rules.

5. The non-transitory computer readable medium of claim 4, wherein the discount applicability rules are based on matching one or more combinations of item counts corresponding to different item types in the item set.

6. The non-transitory computer readable medium of claim 4, wherein the discount applicability rules are based on matching or exceeding a cost threshold for one or more combinations of item counts corresponding to different item types in the item set.

7. The non-transitory computer readable medium of claim 4, wherein the discount applicability rules comprise both matching one or more combinations of item types and/or item count in the item set, and on exceeding a cost threshold for one or more combinations of item types and/or item count in the item set.

8. The non-transitory computer readable medium of claim 6, wherein a cost accumulating tag operator for tracking an accumulated cost of marked items in conjunction with a filter operator for comparing the accumulated cost with a threshold cost are implemented to generate markings for cost threshold based discount applicability rules.

9. The non-transitory computer readable medium of claim 7, wherein a combinatorial optimization is performed on a discount space after eliminating from the discount space one or more irrelevant discounts corresponding to the discount applicability rules that generate the empty set of markings when applied to the item set.

10. A computer-implemented method for determining irrelevant match conditions from a plurality of match conditions for an item set, the method comprising:
associating each item in the item set with one or more tags;
characterizing each of the plurality of match conditions as a Boolean function of one or more tag operators, wherein each tag operator comprises the one or more tags, and wherein each tag operator generates a set of possible markings of the item set, wherein each marking in the set of possible markings is generated by removal of one unit of a different single item from the item set that matches the tag operator; and
eliminating match conditions that generate an empty set of markings when applied to the item set.

11. The computer-implemented method of claim 10, wherein the item set comprises a set of purchased items.

12. The computer-implemented method of claim 11, wherein the match conditions comprise discount applicability rules that are based on matching one or more combinations of item counts corresponding to different item types in the item set.

13. The computer-implemented method of claim 11, wherein the match conditions comprise the discount applicability rules that are based on matching or exceeding a cost threshold for one or more combinations of item counts corresponding to different item types in the item set.

14. The computer-implemented method of claim 11, wherein the discount applicability rules comprise both matching one or more combinations of item types and/or item count in the item set, and on exceeding a cost threshold for one or more combinations of item counts corresponding to different item types in the item set.

15. The computer-implemented method of claim 14, wherein a cost accumulating tag operator for tracking an accumulated cost of marked items in conjunction with a filter operator for comparing the accumulated cost with a threshold cost are implemented to generate markings for cost threshold based discount applicability rules.

16. A system for determining irrelevant match conditions from a plurality of match conditions for an item set, comprising:
a data receiving module configured to receive an item set and associate each item in the item set with one or more tags;
an optimizer module configured to determine irrelevant match conditions from a plurality of match conditions for the item set, the determining comprising:
characterizing each of the plurality of match conditions as a Boolean function of one or more tag operators, wherein each tag operator comprises the one or more tags, and wherein each tag operator generates a set of possible markings of the item set, wherein each marking in the set of possible markings is generated by removal of one unit of a different single item from the item set that matches the tag operator; and
eliminating match conditions that generate an empty set of markings when applied to the item set

17. The system of claim 16, wherein the item set comprises a set of purchased items.

18. The system of claim 17, wherein the match conditions comprise discount applicability rules that are based on matching one or more combinations of item counts corresponding to different item types in the item set.

19. The system of claim 17, wherein the discount applicability rules comprise both matching the one or more combinations of item types and/or item count in the item set, and on exceeding a cost threshold for one or more combinations of item counts corresponding to different item types in the item set.

20. The system of claim 19, wherein a cost accumulating tag operator for tracking an accumulated cost of marked items in conjunction with a filter operator for comparing the accumulated cost with a threshold cost are implemented to generate markings for cost threshold based discount applicability rules.
